(19) United States
(12) Patent Application Publication
(10) Pub. No.: US 2006/0045810 A1
(43) Pub. Date: Mar. 2, 2006

(54) Sample injector for liquid analysis

(76) Inventors: Konstantin Choikhet, Karlsruhe (DE); Hans-Georg Weissgerber, Straubenhardt (DE); Wolfgang Kretz, Waldbronn (DE)

Correspondence Address: PERMAN & GREEN, 425 POST ROAD, FAIRFIELD, CT, 06824, US

(21) Appl. No.: 10/928,962

(22) Filed: Aug. 27, 2004

(51) Int. Cl. B01L 3/00

(52) U.S. Cl. 422/100

(57) ABSTRACT

A sample injector for a liquid analysis device includes a multi-route switching valve and a sample conduit. The valve alternatively connects a solvent pump directly to a chromatographic column or via a sample conduit. The sample injector further has a flush solvent delivery device. The flush solvent delivery device delivers at least one flush solvent to the sample conduit of the sample injector. The sample injector also has a sample intake device. The sample intake device provides liquid sample to the sample conduit.

### BACKGROUND ART

The invention relates to chemical, biological and/or physical separation and/or analysis devices. More particularly the invention relates to a sample injector for a liquid analysis device. Such injectors are used, for example, for injecting a sample to be chromatographically separated into a chromatographic column.

Known injection systems typically comprise a sample conduit which can be connected to a chromatographic system, for example, a solvent pump and a column, by one or several valves, and through which solvent can flow at high pressure. The U.S. Pat. No. 4,939,943, for example, discloses a sample injector for a liquid chromatograph with a valve for alternatively connecting the solvent pump directly to the chromatographic column or via the sample conduit of the sample injector. Other approaches are disclosed, for example, in the JP 2001242181 A, U.S. 2002/0102185 A1, or JP 9127078 A. Parts of the sample can adsorb to inner surfaces of the sample injector. This can lead to so-called memory or carry-over-effects in particular if different analyses with different solvents are carried out with the sample injector. Parts of the sample of an earlier analysis can mix with the sample of the current analysis.

### DISCLOSURE OF THE INVENTION

For these aforementioned reasons, it is an object of the invention to provide an improved injecting for liquid analysis devices. More specifically, to provide an improved injector for a liquid analysis device, for example a liquid chromatography device, and methods for minimizing memory and/or carry-over-effects.

The object is achieved by the independent claims. Preferred embodiments are shown by the dependent claims.

According to the present invention, a sample injector for a liquid analysis device is proposed. The sample injector comprises a sample conduit and a multi-route switching valve adapted for alternatively connecting a solvent pump directly to a chromatographic column of the liquid analysis device, or via the sample conduit of the sample injector. Besides this, the sample injector comprises a sample intake device adapted for admitting a liquid sample into or rather for providing the liquid sample to the sample conduit.

Embodiments may comprise one or more of the following. Multi-route switching valves, in particular 6/2 way valves, are known in the art. Such valves comprise at least two settings and are adapted for switching a plurality of, in particular 6, ports. Commonly, a plurality of pairs, in particular of three pairs, of ports can be coupled or separated from each other by such valves. The valves can comprise a revolving valve element with fluid conducting grooves for switching the ports. Besides this, solvent pumps are known in the art. Such pumps are adapted for delivering a solvent at a more or less high pressure for executing a chromatography process, for example a high-pressure liquid chromatography process, within a chromatographic column. Normally, such pumps are realized as binary pumps for delivering a time-variable gradient of two different solvents as well known in the art. Sample intake devices are known in the art as well. Such intake devices normally comprise an injecting needle that can be brought in contact with the sample; in particular dipped in a sample vial, and are fluidically coupled to the sample conduit for injecting the sample into the chromatographic column. Therefore, the sample injector and the liquid analysis device are adapted for executing a liquid analysis or rather a plurality of liquid analyses of liquid samples such as high pressure liquid chromatography, or alike.

Advantageously, the sample injector comprises a flush solvent delivery device. The device is adapted for delivering at least one flush solvent to the sample conduit. The flush solvent can be delivered to the sample conduit before and after a sample injection, for example at a low pressure. The flush solvent can clean the inner surface of the sample injector or rather of the sample conduit of the sample injector from any adhering sample remains. The flushing process can take place in a setting of the multi-route switching valve, wherein the solvent pump is coupled directly to the chromatographic column. Advantageously, the gradient delivered by the solvent pump, for example at a high pressure, can reach the chromatographic column without the time delay of the relatively long sample conduit.

The analysis of a sample within the chromatographic column can take place in parallel with the flushing process. The according setting of the multi-route switching valve is referred to as “by-pass mode” in this application. Another setting, used for conducting the liquid sample to the column via the sample conduit, is referred to as “loop mode” in this application. It can be seen that the advantage of a direct delivery of the solvent gradient to the chromatographic column comes with the disadvantage of exclusion of contact of the inner surface of the sample conduit with the whole gradient profile and especially with its part including strong eluent composition. This start eluent delivered at the beginning of a chromatographic analysis and being normally the only eluent composition that comes in contact with the inner surface of the sample conduit is generally a rather weak solvent. Therefore, any rests or rather remains of the sample can adhere to the inner surface of the sample conduit. Advantageously, such rests of the sample can be flushed out by using the flush solvent delivery device. The flush solvent delivery device makes it possible to combine the two advantages of a minimal memory or rather carry-over-effect and a time optimized processing of different samples, enabled by processing the analysis and flushing the sample conduit concurrently in by-pass mode.

Embodiments may comprise one or more of the following. Advantageously, the flush solvent delivery device can comprise different flush solvent sources to be connected with the sample conduit by a high-pressure selection valve. The high-pressure selection valve comprises one main port and a plurality of selection ports and is adapted for connecting the plurality of selection ports alternatively to the main port at a high pressure. The main port is coupled to the sample conduit, and the selection ports are coupled to the different flush solvent sources. Advantageously, the flush solvent sources can comprise different solvents with different solvent powers. Especially advantageously, one of the solvents is the start eluent delivered by the solvent pump at the beginning of a chromatographic analysis. The start eluent has the same chemical composition necessary at the beginning of the analysis of the sample within the liquid chromatographic column. Advantageously, the sample conduit can be flushed first with the different flush solvents and finally with the start eluent. This guarantees that at the beginning of an analysis process, the whole system, the sample injector, the sample conduit, and the analysis device, comprise the same condition. The flush solvent delivery device can comprise a flush solvent pump adapted for coupling the sample conduit alternatively with the flush solvent sources and for pumping the flush solvent into the sample conduit.

Embodiments may comprise one or more of the following. Advantageously, the sample conduit comprises a buffer capillary. The buffer capillary is switched between a metering device and a coupling point. The sample conduit is coupled to the flush solvent delivery device at the coupling point. Metering devices are known in the art and serve for an exact metering of the sample. Such devices usually comprise a movable piston. Advantageously, at least part of the buffer capillary can be used for storing the flush solvent without wetting the metering device with any flush solvent. After storing, the flush solvent can be transported through the sample conduit by the metering device.

Another aspect of the present invention relates to a method of operating a sample injector for a liquid analysis device comprising a multi-route switching valve, in particular a 6/2-way valve. The valve is adapted for alternatively connecting a solvent pump directly to a chromatographic column of the liquid analysis device (by-pass mode) or via a sample conduit of the sample injector to the column (loop mode). The sample injector comprises a flush solvent delivery device for delivering at least one flush solvent to the sample conduit of the sample injector and a sample intake device for providing a liquid sample to or rather for admitting into the sample conduit. Firstly, after accomplishing the sample transfer to the column and switching from loop to by-pass mode, the sample conduit is flushed with a first flush solvent delivered by the flush solvent delivery device. Thereafter, the sample conduit is flushed with a second flush solvent delivered by the flush solvent delivery device. Embodiments may comprise one or more of the following. Advantageously, the sample conduit can be flushed by the flush solvent delivery device with two different flush solvents for avoiding any carry over or memory effects. Advantageously, the steps can be executed while running an analysis with the liquid analysis device.

### BRIEF DESCRIPTION OF DRAWINGS

Other objects and many of the attendant advantages of embodiments of the present invention will be readily appreciated and become better understood by reference to the following more detailed description of preferred embodiments in connection with the accompanied drawings. Features that are substantially or functionally equal or similar will be referred to with the same reference signs.

FIG. 1 shows a schematic hydraulic layout of a sample injector with a 6/2 way valve, a sample conduit, and a high-pressure selection valve;

FIG. 2 shows the layout of FIG. 1, wherein the valves are shown in different settings;

FIG. 3 shows another schematic hydraulic layout of a sample injector with a 6/2 way valve, a sample conduit, and a high-pressure selection valve;

FIG. 4 shows the layout of FIG. 3, wherein the valves are shown in different settings;

FIG. 5 shows another schematic hydraulic layout of a sample injector with a 6/2 way valve, a sample conduit, and a high-pressure selection valve; and

FIG. 6 shows the layout of FIG. 5, wherein the valves are shown in different settings.

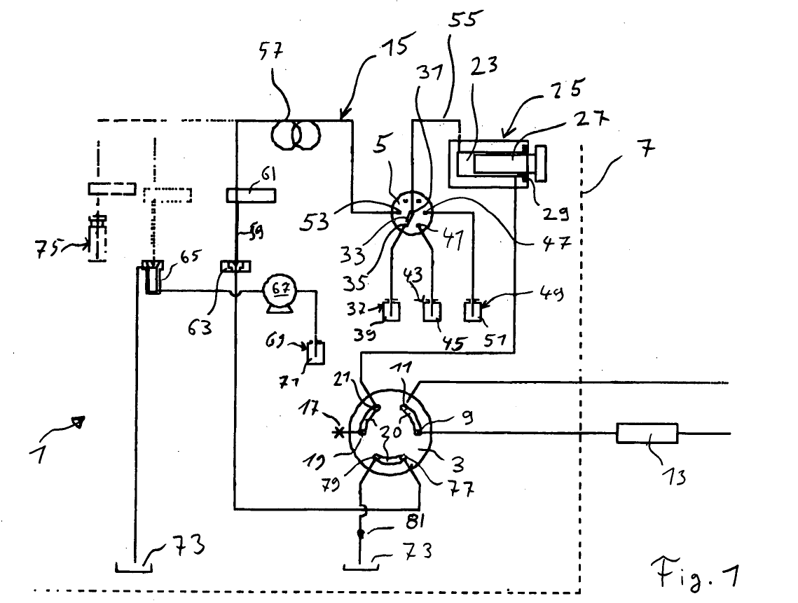

FIG. 1 shows a schematic hydraulic layout of a sample injector 1 with a 6/2-way valve 3 and a high-pressure selection valve 5.

A dashed line 7 indicates the system limit of the sample injector 1. Behind the system limit—as indicated with the dashed line 7—not shown parts of a liquid analysis device, for example a liquid chromatography device, are arranged. The not shown liquid analysis device or rather liquid chromatography device is coupled to the 6/2-way valve 3 of the sample injector 1. The liquid chromatography device comprises a column 13 coupled to a column port 9 of the 6/2-way valve 3 of the sample injector 1. A “chromatography device” as referred to in this application is to be understood as any device including any according periphery, for example any kind of separation column and any kind of solvent delivery unit, e.g., solvent pump, adapted for analyzing and/or separating a liquid sample, wherein the sample has to be fed into the device. The not shown solvent gradient pump of the also not shown liquid chromatography device is coupled to an eluent inlet port 11 of the 6/2 way valve 3 of the sample injector 1. In the setting of the 6/2-way valve 3 as shown in FIG. 1, the gradient solvent pump and the column 13 of the not shown liquid chromatography device are coupled directly via the valve 3. In other words, the 6/2-way valve 3 of the sample injector 1 realizes a by-pass for connecting the gradient solvent pump and the column 13 of the not shown chromatography device without including a sample conduit 15 of the sample injector 1. The sample conduit 15 can be part of a high pressure liquid analysis arrangement adapted for executing any liquid analysis process, for example a high pressure liquid chromatography process.

In the by-pass mode, the sample conduit 15 of the sample injector 1 is completely separated from the chromatography device. In this embodiment the sample conduit 15 of the sample injector 1 starts with a plug 17, or alike. The plug 17 is coupled downstream to a plug port 19 of the 6/2-way valve 3 of the sample injector 1. The 6/2-way valve 3 comprises grooves 20 for connecting ports of the 6/2-way valve 3.

In the setting of the 6/2 way valve 3 as shown in FIG. 1 (by-pass mode), the plug port 19 is coupled by one of the grooves 20 to an inlet metering port 21 6/2 way valve 3. The metering device 25 comprises two openings or rather ports being coupled to a hollow cylinder 23. The metering port 21 is coupled downstream to the hollow cylinder 23 of a metering device 25 via one of the two openings or rather ports. The metering device 25 comprises a piston 27 inserted into the hollow cylinder 23 of the metering device 25. The piston 27 has a smaller diameter than the hollow cylinder 23 and is sealed with a high-pressure seal 29. For metering any liquid with the metering device 25, the piston 27 can be moved within the hollow cylinder 23. The volume intake of the piston 27 within the hollow cylinder 23 of the metering device 25 is equal to the metered amount of liquid. Metering devices are well known in the art and therefore not described in detail in this application.

The hollow cylinder 23 of the metering device 25 is coupled downstream to a main port 31 of the high-pressure selection valve 5 via a buffer capillary 55. The metering device 25 comprises the two openings or rather ports being coupled to the hollow cylinder 23. A first opening of the metering device 25 is coupled to the main port 31 of the high-pressure selection valve 5 and a second opening to the metering port 21 of the 6/2-way valve 3. The main port 31 of the high-pressure selection valve 5 can be connected alternatively to a plurality of selection ports by a movable groove 33. A first selection port 35 of the high-pressure selection valve 5 is coupled upstream to a first solvent vial 37 containing a first flush solvent 39. A second selection port 41 is coupled upstream to a second solvent vial 43 containing a flush solvent 45. A third selection port 47 is coupled upstream to a third solvent vial 49 containing a start eluent 51. The start eluent 51 has the same chemical composition as a start eluent delivered by the gradient solvent pump of the not shown chromatography device at the beginning of a chromatographic analysis and it may be taken from the same vessel or conduit as the start eluent for the chromatography.

For closing the sample conduit 15 the sample injector 1 the main port 31 can be coupled to a fourth selection port 53 by the groove 33 of the high-pressure selection valve 5.

The main port 31 of the high-pressure selection valve 5 is coupled via the buffer capillary 55 to the hollow cylinder 23 of the metering device 25. The buffer capillary 55 is adapted for storing one of the flush solvents or the eluent solvent. Therefore, the buffer capillary 55 can be filled partly, advantageously to a maximum value of 50%. Advantageously, one of the flush solvents of the vials 37 and 43 can be drawn by the metering device 25—against the flow direction of the sample conduit 15—into the buffer capillary 55 without wetting any parts of the metering device 25, in particular the hollow cylinder 23 or the piston 27, with any flush solvent 39 and 45.

The vials 37, 43, and 49, the high-pressure selection valve 5, the buffer capillary 55, and the metering device 25 can realize a flush solvent delivery device adapted for delivering at least one flush solvent 39, 45 to the sample conduit 15 of the sample injector 1. The main port 31 of the high-pressure selection valve 5 realizes a coupling point for coupling the flush solvent delivery device to the sample conduit 15.

The fourth selection port 53 of the high-pressure selection valve 5 is coupled downstream to sample loop 57. The sample loop 57 is adapted for storing any sample drawn by the metering device 25. The sample can be stored in the sample loop 57 without wetting any parts of the high-pressure selection valve 5 and/or the metering device 25.

The sample loop 57 of the sample conduit 15 is coupled downstream to a needle 59. The needle 59 is coupled with an actuator for moving the needle 59. In FIG. 1 three different positions of the needle 59 or rather the actuator 61 are indicated. In a first position as shown in FIG. 1 with normal lines, the needle 59 is positioned in a needle seat 63. The needle seat 63 realizes a fluid-tight connection between the needle 59 and the sample conduit 15. In this position, a sample contained within the needle 59 can be admitted into or rather provided to the sample conduit 15.

In a second position, as illustrated in FIG. 1 with dotted lines, the needle 59 is positioned above or in a wash port 65. The wash port 65 is coupled upstream to a wash low-pressure pump 67. The wash pump 67 is coupled upstream to a vial 69 containing a wash solvent 71. The wash solvent 71 can be pumped by the wash pump 67 to the wash port 65 for rinsing the outside or rather the outer surface of the needle 59. This is helpful for avoiding any contamination of the needle seat 63 with any sample. The wash port 65 is coupled downstream to a waste 73.

In a third position, as illustrated in FIG. 1 with dash-dotted lines, the actuator 61 and the needle 51 are positioned within any sample vial 75 for drawing the sample from the sample vial 75 into the sample conduit 15 or rather into the sample loop 57 of the sample conduit 15 with the metering device 25. The actuator 61, the needle 51, the sample vial 75, the sample loop 57, and the metering device 25, are parts of a sample intake device adapted for providing liquid sample to the sample conduit 15.

For drawing the sample, the 6/2-way valve 3 has to be set in the by-pass mode and the main port 31 and the fourth selection port 53 of the high-pressure selection valve 5 has to be connected by the groove 33 of the high-pressure selection valve 5.

The needle seat 63 is coupled downstream to a seat port 77 of the 6/2-way valve 3. In the setting as shown in FIG. 1, the seat port 77 is coupled to a waste port 79 of the 6/2-way valve 3 by one of the grooves 20. The waste port 79 can be coupled downstream to the waste 73 via a restriction capillary 81. The restriction capillary 81 can be replaced by a flow check valve. The restriction 81 prevents the liquid from flowing back.

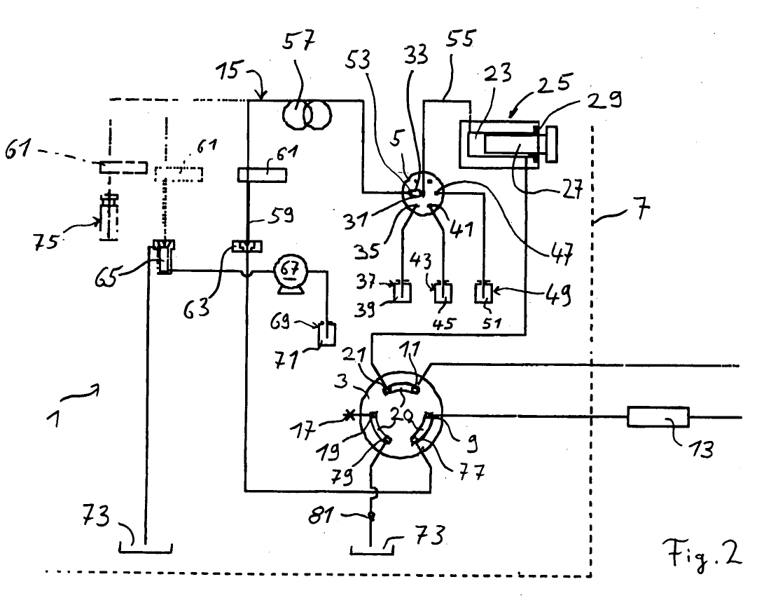

FIG. 2 shows the layout of FIG. 1, wherein the 6/2-way valve 3 and the high-pressure selection valve 5 are shown in another setting. In this setting the 6/2 way valve 3 connects the not shown solvent gradient pump with the sample conduit 15 or rather with the metering device 25 via the inlet port 11, via the groove 20, via the metering port 21. The high-pressure selection valve 5 is shown in a closed loop setting wherein the groove 33 connects the fourth selection port 53 with the main port 31 of the high-pressure selection valve 5. With other words, in this setting the sample conduit 15 is closed and the hollow cylinder 23 of the metering device 25 is coupled directly to the sample loop 57 of the sample conduit 15 of the sample injector 1. In this setting any sample drawn into the needle 59 can be transported by the flow generated by the solvent pump to the chromatographic column 13. For this purpose, the needle seat 63 is coupled downstream to the chromatographic column 13 via the seat port 77, via one of the grooves 20, and via the column port 9 of the 6/2-way valve 3. The setting of the valves 3 and 5 as shown in FIG. 2 is referred to as “loop mode” in this application. In the loop mode, the solvent gradient pump is coupled to the column 13 via the whole sample conduit 15 of the sample injector 1.

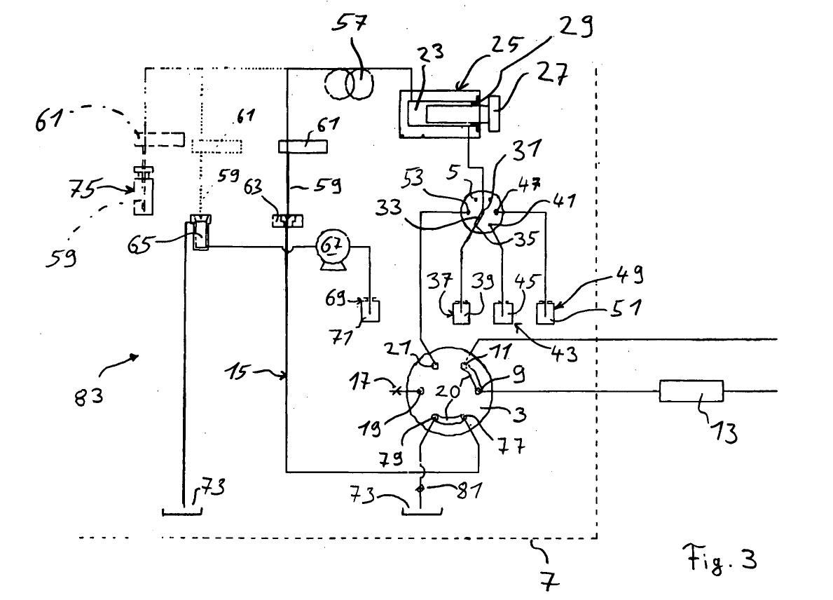

FIG. 3 shows another layout of a sample injector 83. Different from the sample injector 1 as shown in the FIGS. 1 and 2, the sample injector 83 comprises no buffer capillary 55. The high-pressure selection valve 5 is coupled downstream to the hollow cylinder 23 of the metering device 25 via the main port 31. The flush solvents 39 and 45 and the start eluent 51 can flow upstream—in flow direction of the sample conduit 15 as given in the loop mode—directly into the hollow cylinder 23 of the metering device 25. Therefore, the high-pressure selection valve 5 has to be set in different settings.

In this layout the inner parts of the metering device 25 can be wetted with flush solvents and consequently flushed also. For flushing the sample conduit 15, flush solvent 39 and 45 can be drawn into the hollow cylinder 23 by the piston 27 of the metering device 25. In a second step, the high-pressure selection valve 5 can be switched to the fourth selection port 53. In the layout as shown in FIG. 3, the fourth selection port 53 of the six ports of the high-pressure selection valve 5, is coupled upstream to the metering port 21 of the 6/2 way valve 3 of the sample injector 83. The metering port 21 of the 2/6-way valve 3 is closed in the setting as shown in FIG. 3. Therefore, the flush solvent can't flow back while pushing it into the sample conduit 15 by the metering device 25 after flush solvent is drawn and the high-pressure selection valve is switched to the port 53. Alternatively, for this purpose, the high pressure selection valve 5 can be set to a position, for example to a blind or closed port, wherein the main port 31 is closed.

Besides this, for an exact metering of the sample by the sample intake device the opening of the metering device 25 being connected to the main port 31 or rather to the metering port 21 has to be closed also in the same manner. The waste port 79 is coupled downstream to the waste 73 via a restriction capillary 81. The restriction capillary 81 can be replaced by a flow check valve. The restriction capillary 81 prevents the liquid from flowing back during drawing any solvent 39, 45, and 51 from any of the vials 37, 43, and 49 by means of the metering device 25.

As a further difference, the sample conduit 15 of the sample injector 83 is closed directly by the 6/2-way valve 3. As another difference, the 6/2-way valve 3 of the sample injector 83 comprises just two of the grooves 20 and the six ports as described above for this purpose. Possibly such a modified 6/2-way valve 3 can be employed for the layout of FIGS. 1 and 2 also.

In embodiments, the vials 37, 43, and 49, the high-pressure selection valve 5, and the metering device 25 can realize the flush solvent delivery device adapted for delivering at least one flush solvent to the sample conduit 15 of the sample injector 83.

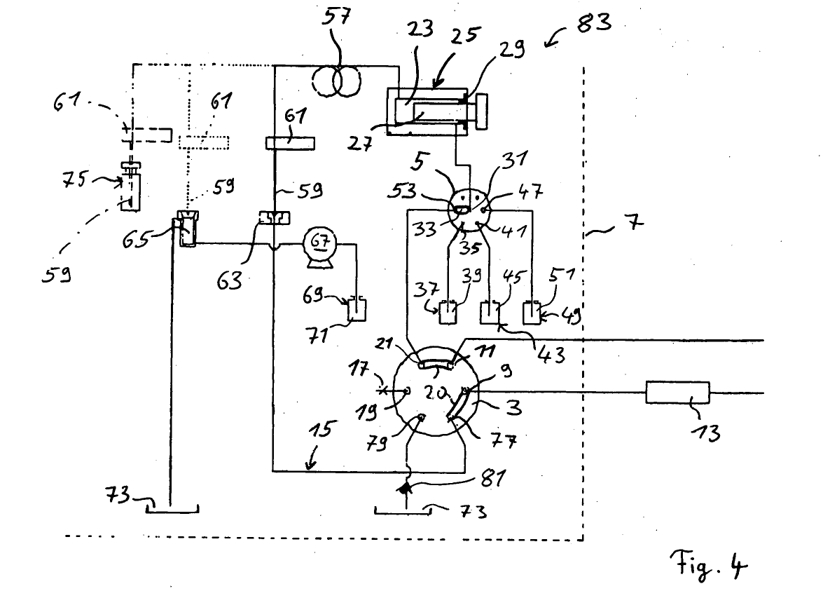

FIG. 4 shows the same sample injector 83 as shown in FIG. 3, but with different settings of the 6/2-way valve 3 and the high-pressure selection valve 5. In the setting as shown in FIG. 4, the gradient solvent pump—not shown—is coupled directly to the fourth selection port 53 of the high-pressure selection valve 5 via the inlet port 11, via the groove 20, and via the metering port 21 of the 6/2 way valve 3.

The high-pressure selection valve 5 is shown in a setting wherein the fourth selection port 53 is coupled to the main port 31. With other words, the sample conduit 15 is closed in this setting and shown in FIG. 4 in the loop mode. As described above, the not shown gradient solvent pump can push any sample contained within the sample conduit 15, for example stored in the sample loop 57, into the chromatographic column 13 of the not shown chromatography device via the 6/2 way valve 3 in this setting.

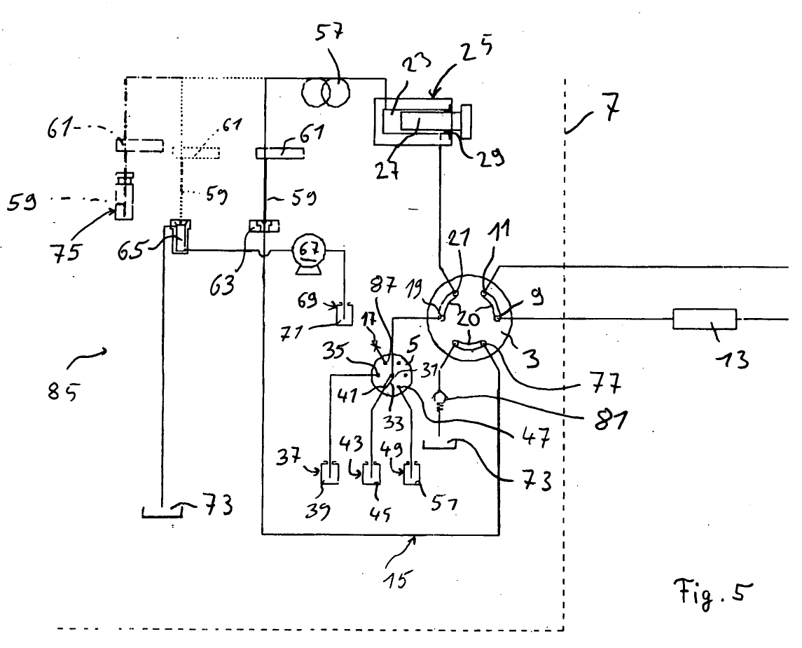

FIG. 5 shows another schematic hydraulic layout of a sample injector 85 in the by-pass mode.

Different from the sample injectors 83 and 1 as described above, the plug port 19 of the 6/2 way valve 3 can be coupled upstream to the plug 17 via the main port 31, via one of the grooves 33, and via a fifth selection port 87 of the high pressure selection valve 5. In other words, the high-pressure selection valve 5 is arranged upstream of the 6/2 way valve 3 in the sample conduit 15. For this purpose, it is essential, that the 6/2-way valve 3 comprises three grooves, wherein one of the grooves 20 of the 6/2-valve has to be adapted for connecting the ports 19 and 21 respectively the ports 19 and 79.

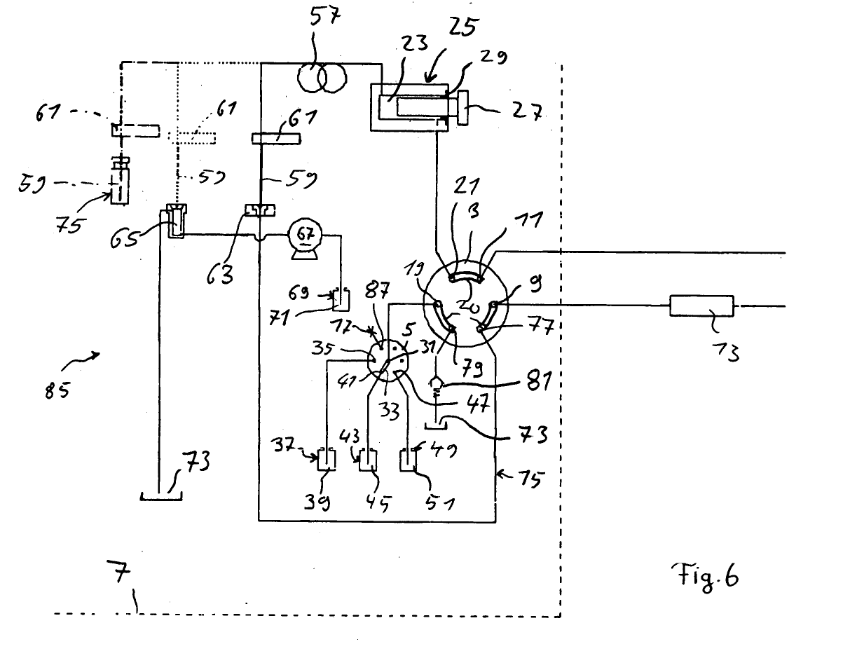

In the settings of the valves 3 and 5 as shown in FIG. 5, the metering device 25 can draw any flush solvent 39 or 45 or any start eluent 51 via one of the selection ports 35, 41 and 47, via the groove 33, via the main port 31 of the high-pressure selection valve 5, via the plug port 19, via the groove 20, and via the metering port 21 of the 6/2 way valve 3. The metering device 25 can draw the solvent and/or the start eluent in flow direction of the sample conduit 15—as given in the loop mode (see FIG. 6). In this configuration of the sample injector 85, the selection valve 5 and the 6/2-way valve 3 and the metering device 25 are all flushed with the flush solvents.

In embodiments, the high-pressure selection valve 5 can be replaced by a normal selection valve or by other suited low-pressure valves, for example normal switching valves. The high-pressure selection valve 5 is arranged in the layout according to FIG. 5 in a low-pressure channel. The maximum pressure is determined substantially by the flow resistance of the restriction capillary 81 and by the flow induced by the metering device 25 while flushing the sample conduit 15.

In other embodiments, the vials 37, 43, and 49, the selection valve 5, the 6/2 way valve 3, and the metering device 25 can realize the flush solvent delivery device adapted for delivering at least one flush solvent to the sample conduit 15 of the sample injector 85.

The actuator 61, the needle 51, the sample vial 75, the sample loop 57, and the metering device 25, are parts of a sample intake device adapted for providing liquid sample to the sample conduit 15. For taking in any sample—in by-pass mode as shown in FIG. 5—into the sample conduit 15, the connection of the hollow cylinder 23 of the metering device 25 to the metering port 21 of the 6/2-way valve 3 has to be closed. For this purpose, the selection valve 5 has to be switched to the fifth selection port being connected to the plug 17 or realized as a closed blind port.

FIG. 6 shows the sample injector 85 as shown in FIG. 5, wherein the 6/2-way valve 3 is shown in a second setting. In the setting as shown in FIG. 5, the sample conduit 15 is coupled to the second flush solvent vial 45 and to the waste 73. In the setting as shown in FIG. 6, the sample conduit 15 of the sample injector 85 is switched between the solvent gradient pump and the chromatographic column 13 by the 6/2-way valve 3 (loop mode).

The metering device 25 is a functional part of the sample intake device and of the flush solvent delivery device adapted for metering and/or transporting the sample and for transporting the flush solvents within the sample conduit 15.

Advantageously, with the layouts of the FIG. 3 to 6 the sample conduit 15 can be flushed forwards. Besides this, no modification of the sample conduit 15 adapted for conducting liquids under high pressure is necessary, for example by switching the high-pressure selection valve 5 in the sample conduit 15 as shown in FIGS. 1 and 2.

In embodiments, alternatively, the flush solvent delivery device can comprise a flush solvent pump adapted for coupling the sample conduit alternatively with the vials 37, 43, and 49 and for pumping at least one flush solvent 39, 45 into the sample conduit 15. The metering device 25 is not necessary for transporting the flush solvent 39, 45. The flush solvent pump can deliver a continuous flow of flush solvents.

In embodiments, the 6/2-way valve can be replaced with another suited multi-route switching valve.

In the following a method for operating a sample injector is described by referring to the Figure(s) as described above.

In a first step, after accomplishing the sample transfer to the column and switching from loop to by-pass mode, the sample conduit 15 is flushed with the first flush solvent 39 delivered by the flush solvent delivery device comprising the high-pressure selection valve 5 and the vials 37, 43 and 49. Thereafter, the sample conduit 15 of the sample injector 1 is flushed with the second flush solvent 45 also delivered by the flush solvent delivery device.

In embodiments, after flush solvent is drawn, the high-pressure selection valve 5 is set to a closed setting for coupling the metering device 25 and the sample conduit 15 of the sample injector 1 via the main port 31, via the groove 31, and via the fourth selection port 53 of the high-pressure selection valve 5. In a next step, all or part of the drawn flush solvent volume is purgesd by means of the metering device 25 via the sample conduit 15 to the waste 73. Thereafter, the sample conduit is flushed with one or more of the flush solvents 39 and 45 as described above.

Other embodiments may comprise one or more of the following. Additionally, the high-pressure selection valve 5 can be set to an eluent setting for coupling the start eluent vial 49 via the third selection port 47, via the groove 33, via the main port 31 of the high-pressure selection valve 5 to the buffer capillary 55, and to the metering device 25. Thereafter, a percentage, for example 80%, of the volume of the metering device can be used for drawing the start eluent 51 into the buffer capillary 55 and into the metering device 25. In a next step, the setting of the high-pressure selection valve 5 is set to a flush solvent setting. In this setting, the first flush solvent vial 39 is coupled via the first selection port 35, via the groove 33 via the main port 31 of the high-pressure selection valve 5 to the buffer capillary 55. Subsequently, the rest of the volume of the metering device 25, for example 20% of the volume, can be drawn for partly filling the buffer capillary, in particularly up to a maximum of 50%, with the first flush solvent 39. Subsequently, the setting of the high-pressure selection valve 5 is reset to the closed setting, wherein the sample conduit 15 of the sample injector 1 is closed. Thereafter, all content of the metering device 25 is ejected to the waste 73 via the buffer capillary 55 and via the sample conduit 15. In a last step, the steps as described above can be repeated for an arbitrary number of cycles with the first flush solvent 39 or with a second flush solvent 45 instead of the first flush solvent 39.

Other embodiments may comprise one or more of the following. Additionally, just the drawn volume of the first flush solvent, in particular 20% of the volume of the metering device 25, can be ejected after the setting of the high-pressure selection valve 5 is reset to the closed setting. After that, the high-pressure selection valve 5 is set back to one of the flush solvent settings. Subsequently, the rest of said volume can be drawn again for partly filling the buffer capillary 55 with one of the flush solvents 39 or 45. Finally, the high-pressure selection valve 5 is set back to the closed setting. The steps above can be repeated for an arbitrary number of cycles. In other words, the drawn volume, in particular 20% of the volume of the metering device 25, of the flush solvents 39 or 45 can be ejected for multiple times for flushing the sample conduit 15 with the flush solvents 39 or 45 after firstly setting the high pressure selection valve 5 back to the closed setting. After that, all content of the metering device 25 can be ejected via the sample conduit 15 to the waste 73.

Additionally, the high-pressure selection valve 5 can be reset to the eluent setting. After that, a percentage, in particular 100%, of the volume of the metering device 25 can be used for drawing the start eluent 51. After that, the high-pressure selection valve 5 can reset to the closed setting, wherein the sample conduit 15 is closed. Finally, all content of the metering device 25 can be ejected to the waste 73 via the sample conduit 15 as described above. Advantageously, any remaining flush solvent can thus be flushed out of the sample conduit 15.

After that, the sample injector is ready again for taking in a new sample without any carry over and/or memory-effects. For taking in a sample, the sample intake device can be activated while analyzing a sample in the column 13 in the by-pass mode. After finishing the analysis within the chromatography device, the sample injector can be switched to the loop mode for pushing the sample into the column 13 by the flow produced by the solvent gradient pump of the chromatography device. After that, after the sample reached the column 13, the sample injector can be set back to the by-pass mode. Advantageously, the solvent gradient produced by the solvent gradient pump reaches the column without any time-delay caused by the relatively long sample conduit 15. Concurrently, in the by-pass mode, the sample conduit 15 of the sample injector can be flushed, refilled with the start eluent, and loaded with a new sample as described above.

Further embodiments can comprise one or more of the following. The steps as described in the following can be executed with the sample injector 83 or 85 as described in FIG. 3 to 6. Firstly, the high-pressure selection valve 5 can be set to a flush solvent setting, wherein the first flush solvent vial 37 is coupled to the main port 31 of the high-pressure selection valve 5. In the set-up as described in FIG. 3, the main port 31 of the high-pressure selection valve 5 is coupled directly to the metering device 25. In the set-up as described in FIG. 5, the main port 31 is coupled via the 6/2-way valve 3 to the hollow cylinder 23 of the metering device 25. Subsequently, a percentage, in particular 100%, of the volume of the metering device 25 can be used for drawing the first flush solvent 39. There after, the high-pressure selection valve 5 is set back to closed setting, wherein the sample conduit 15 is closed. Finally, all content of the metering device 25 can be ejected to the sample conduit 15 and consequently to the waste 37. The four steps above can be repeated for an arbitrary number of cycles with the first flush solvent 39.

Alternatively the steps can be repeated with the second flush solvent 45 or with the start eluent solvent 51. For flushing out any flush solvent, it is important to refill the whole sample conduit 15 with the start eluent solvent 51 as described by the four steps above.

It is to be understood that this invention is not limited to the particular component parts of the devices described or to process steps of the methods described as such devices and methods may vary. It is also to be understood, that the terminology used herein is for purposes describing particular embodiments only and it is not intended to be limiting. It must be noted that, as used in the specification and the appended claims, the singular forms of “a”, “an”, and “the” include plural referents until the context clearly dictates otherwise. Thus, for example, the reference to “a vial” or “a flush solvent delivery device” includes two or more such functional elements.

1. A sample injector for a liquid analysis device, the sample injector comprising:
a sample conduit being adapted for providing a liquid sample to said liquid analysis device,
a multi-route switching valve adapted for alternatively connecting a solvent pump directly to said liquid analysis device or via said sample conduit,
a flush solvent delivery device adapted for delivering at least one flush solvent to said sample conduit of said sample injector, and
a sample intake device adapted for providing liquid sample to said sample conduit.

2. The sample injector of claim 1, wherein said flush solvent delivery device comprises at least two different flush solvent sources.

3. The sample injector of claim 30, wherein said third eluent solvent source comprises a start eluent with a chemical composition as necessary at the beginning of an analysis of a sample within said liquid analysis device.

4. The sample injector of claim 1, wherein said sample intake device comprises a metering device.

5. The sample injector of claim 1, wherein said flush solvent delivery device is adapted for delivering sa-id flush solvent to said sample conduit in a by-pass mode setting of said multi-route switching valve.

6. The sample injector of claim 1, wherein said flush solvent delivery device comprises a high-pressure selection valve with a main port and a plurality of selection ports.

7. The sample injector of claim 6, wherein said high pressure selection valve is adapted for coupling said sample conduit via said main port alternatively with said solvent sources via said selection ports.

8. The sample injector of claim 1, wherein said sample conduit of said sample injector comprises a buffer capillary, and wherein said flush solvent delivery device is adapted for delivering said flush solvent to said buffer capillary.

9. The sample injector of claim 8, wherein said buffer capillary is coupled upstream to said metering device and downstream to said main port of said high pressure selection valve.

10. The sample injector of claim 9, wherein one of said selection ports of said high pressure selection valve is coupled downstream to said sample conduit.

11. The sample injector of claim 10, wherein said buffer capillary is adapted for storing said flush solvent without wetting said metering device with said flush solvent before flushing said sample conduit.

12. The sample injector of claim 1, wherein said main port of said high pressure selection valve is coupled downstream to said metering device and wherein one of said selection ports of said high pressure selection valve is coupled upstream to said multi-route switching valve.

13. The sample injector of claim 12, wherein said one port of said high pressure selection valve is coupled upstream via said multi-route switching valve alternatively to a plug or to said solvent pump.

14. The sample injector of claim 1, wherein said main port of said high pressure selection valve is coupled downstream to said 6/2 way valve.

15. The sample injector of claim 14, wherein one of said selection ports of said high pressure selection valve is coupled upstream to said plug.

16. The sample injector of claim 1, wherein said flush solvent delivery device comprises a flush solvent pump adapted for coupling said sample conduit alternatively with said flush solvent sources and for pumping said flush solvent into said sample conduit.

17. The sample injector of claim 1, comprising at least one of the following features:
said liquid analysis device is a liquid chromatography device comprising a chromatographic column,
said chromatographic column is coupled to said multi-route switching valve,
said multi-route switching valve is realized as a 6/2 way valve,
a coupling point for coupling said flush solvent delivery device to said sample conduit.

18. A method of operating a sample injector for a liquid analysis device comprising a sample conduit being adapted for providing a liquid sample to said liquid analysis device, a multi-route switching valve adapted for alternatively connecting a solvent pump directly to said liquid analysis device or via said sample conduit, a flush solvent delivery device adapted for delivering at least one flush solvent to said sample conduit of said sample injector, and a sample intake device adapted for providing a liquid sample to said sample conduit, the method comprising
flushing said sample conduit with a first flush solvent delivered by said flush solvent delivery device, and
flushing said sample conduit with a second flush solvent delivered by said flush solvent delivery device.

19. The method of the above claim 18, further comprising:
setting a high pressure selection valve to a closed setting for coupling a metering device to said sample conduit and for closing said sample conduit, and
ejecting all content of said metering device via said sample conduit to a waste before flushing said sample conduit.

20. The method of claim 19, including the additional steps of
setting a high pressure selection valve to an eluent setting for coupling an eluent vial of said flush solvent delivery device to said metering device via said high pressure selection valve and via a buffer capillary,
drawing a first percentage of a volume of said metering device for drawing a start eluent out of said eluent vial,
setting said high pressure selection valve to a first flush solvent setting for coupling a first flush solvent vial of said flush solvent delivery device to said metering device via said high pressure selection valve and via said buffer capillary,
drawing a remaining percentage of said volume of said metering device for filing said buffer capillary partly with a first flush solvent,
setting said high pressure selection valve back to said closed setting, and
ejecting all content of said metering device via said sample conduit to said waste for flushing said sample conduit with said first flush solvent, and
repeating the steps above of this claim for an arbitrary number of cycles with said first flush solvent or with said second flush solvent instead of said first flush solvent.

21. The method of claim 20, including the additional steps of
ejecting said drawn volume of the first flush solvent
setting said high pressure selection valve back to said first flush solvent setting or to a second flush solvent setting,
drawing said rest of said volume again,
setting said high pressure selection valve back to said closed setting,
wherein said additional steps are executed after setting said high pressure selection valve back to said closed setting and before ejecting all content of said metering device, and wherein said additional steps are repeated for an arbitrary number of cycles with said first flush solvent or with said second flush solvent.

22. The method of claim 20, including the additional steps of:
setting said high pressure selection valve back to said eluent setting after ejecting all content of said metering device,
drawing a second percentage, in particular 100%, of said volume of said metering device for drawing said start eluent,
setting said high pressure selection valve back to said closed setting, and
ejecting all content of said metering device via said sample conduit to said waste, and
repeating the steps above of this claim for an arbitrary number of cycles.

23. The method of claim 19, including the additional steps of
setting said high pressure selection valve to said first flush solvent setting for coupling said first flush solvent vial of said flush solvent delivery device via a 6/2 way valve or directly to said metering device,
drawing a third percentage of said volume of said metering device for drawing said first flush solvent,
setting said high pressure selection valve back to said closed setting,
ejecting all content of said metering device via said sample conduit to said waste for flushing said sample conduit with said first flush solvent,
repeating the steps above of this claim for an arbitrary number of cycles with said first flush solvent or with said second flush solvent instead of said first flush solvent.

24. The method of the above claim 23, including the additional step of removing any remains of said flush solvents within said metering device and said sample conduit by repeating the five steps of claim 23 with said start eluent instead of said flush solvents.

25. A method of operating a sample injector for a liquid analysis device comprising a sample conduit having a buffer capillary and being adapted for providing a liquid sample to said liquid analysis device, a multi-route switching valve adapted for alternatively connecting a solvent pump directly to said liquid analysis device or via said sample conduit, a flush solvent delivery device adapted for delivering at least one flush solvent to said sample conduit of said sample injector, and a sample intake device adapted for providing a liquid sample to said sample conduit, the method comprising:
drawing a flush solvent delivered by said flush solvent delivery device into said buffer capillary, and
flushing said sample conduit with said flush solvent.

26. The method of claim 25, including the additional steps of
setting a high pressure selection valve to a closed setting for coupling a metering device to said sample conduit and for closing said sample conduit, and
ejecting all content of said metering device via said sample conduit to a waste before flushing said sample conduit.

27. The method of claim 26, including the additional steps of
setting a high pressure selection valve to an eluent setting for coupling an eluent vial of said flush solvent delivery device to said metering device via said high pressure selection valve and via a buffer capillary,
drawing a first percentage of a volume of said metering device for drawing a start eluent out of said eluent vial,
setting said high pressure selection valve to a first flush solvent setting for coupling a first flush solvent vial of said flush solvent delivery device to said metering device via said high pressure selection valve and via said buffer capillary,
drawing a remaining percentage of said volume of said metering device for filing said buffer capillary partly with a first flush solvent,
setting said high pressure selection valve back to said closed setting, and
ejecting all content of said metering device via said sample conduit to said waste for flushing said sample conduit with said first flush solvent, and
repeating the steps above of this claim for an arbitrary number of cycles with said first flush solvent or with said second flush solvent instead of said first flush solvent.

28. The method of claim 27, including the additional steps of
ejecting said drawn volume of the first flush solvent,
setting said high pressure selection valve back to said first flush solvent setting or to a second flush solvent setting,
drawing said rest of said volume again,
setting said high pressure selection valve back to said closed setting,
wherein said additional steps are executed after setting said high pressure selection valve back to said closed setting and before ejecting all content of said metering device, and wherein said additional steps are repeated for an arbitrary number of cycles with said first flush solvent or with said second flush solvent.

29. The method of claim 27, including the additional steps of
setting said high pressure selection valve back to said eluent setting after ejecting all content of said metering device,
drawing a second percentage of said volume of said metering device for drawing said start eluent,
setting said high pressure selection valve back to said closed setting, and
ejecting all content of said metering device via said sample conduit to said waste, and
repeating the steps above of this claim for an arbitrary number of cycles.

30. The sample injector of claim 1, wherein said flush solvent delivery device comprises at least a first flush solvent, a second flush solvent, and a third eluent solvent source.

31. The method of claim 20, wherein the first drawn percentage of the volume of the metering device for drawing a start eluent is 80%, and the drawn remaining percentage of said volume of said metering device for partly filing said buffer capillary with a first flush solvent is 20%.

32. The method of claim 22, wherein the second drawn percentage of the volume of the metering device for drawing a start eluent is 100%.

33. The method of claim 23, wherein the third drawn percentage of the volume of the metering device for drawing the first flush solvent is 100%.

34. The method of claim 27, wherein the first drawn percentage of the volume of the metering device for drawing a start eluent is 80%, and the drawn remaining percentage of said volume of said metering device for partly filing said buffer capillary with a first flush solvent is 20%.

35. The method of claim 29, wherein the second drawn percentage of the volume of the metering device for drawing a start eluent is 100%.
